(19) United States
(12) Patent Application Publication
(10) Pub. No.: US 2026/0353192 A1
(43) Pub. Date: Nov. 5, 2026

(54) VICTIM PRIORITIZATION FOR CROSSLINK INTERFERENCE HANDLING IN TDD AND SBFD SYSTEMS

(71) Applicant: Lenovo (Singapore) Pte. Ltd., Singapore (SG)

(72) Inventors: Khaled Nafez Rauf ARDAH, Ilmenau (DE); Ali Ramadan ALI, Kraiburg am Inn (DE); Majid GHANBARINEJAD, Chicago, IL (US); Vijay NANGIA, WOODRIDGE, IL (US); Hyejung JUNG, Palatine, IL (US)

(21) Appl. No.: 19/113,263

(22) PCT Filed: Sep. 27, 2023
(86) PCT No.: PCT/IB2023/059637

§ 371 Date: Mar. 19, 2025

Related U.S. Application Data
(60) Provisional application No. 63/377,491, filed on Sep. 28, 2022.

(51) Int. Cl. H04W 28/18; H04W 28/02; H04W 52/24

(52) U.S. Cl. CPC H04W 28/18; H04W 28/0268; H04W 52/243

(57) ABSTRACT

Various aspects of the present disclosure relate to selecting at least one priority value based on at least one criterion, transmitting a message including the at least one priority value to a node in the network, and receiving a response to the message from the node, wherein the selecting entity receives cross-link interference from the node. The at least one priority value may be used to improve communications in the presence of crosslink interference.

### CROSS REFERENCE TO RELATED APPLICATIONS

This application claims priority to U.S. Provisional Patent Application No. 63/377,491, filed on Sep. 28, 2022, which is hereby incorporated by reference in its entirety.

### TECHNICAL FIELD

The present disclosure relates to wireless communications, and more specifically to prioritization in the presence of crosslink interference.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In dynamic time division duplex (TDD) and sub-band full duplex (SBFD) wireless communication systems, gNB-gNB crosslink interference (CLI) and UE-UE CLI can limit and degrade system performance, especially compared to static TDD. In practice, aggressor nodes, which can be base stations or UEs, typically have multiple victims, especially in dense deployment scenarios. Due to its limited capability, e.g., the limited number of antennas (i.e., limited beams) and limited power-time-frequency resources, finding the best trade-off between maximizing the aggressor's signal quality and minimizing the interference towards the victim nodes presents significant challenges.

### SUMMARY

The present disclosure relates to methods, apparatuses, and systems that support improving the quality of network communications in the presence of crosslink interference. A victim node may transmit one or more priority value to an aggressor node, which uses the one or more priority value to selectively adapt transmission parameters to improve communications for the victim node.

Some implementations of the method and apparatuses described herein may further include selecting at least one priority value based on at least one criterion, transmitting a message including the at least one priority value to a second node in the network, and receiving a response to the message from the second node, wherein the first node receives cross-link interference from the second node.

In some implementations of the method and apparatuses described herein, the at least one criterion includes one or more of a QoS requirement for user equipment coupled to the first node, channel quality of a channel that is affected by cross-link interference from the second node, and a power level of the crosslink interference between the first node and the second node.

In some implementations of the method and apparatuses described herein, each priority value of the at least one priority value is respectively associated with a sub-band of a plurality of sub-bands shared between the first node and the second node.

In some implementations of the method and apparatuses described herein, each priority value of the at least one priority value is respectively associated with a beam of a plurality of beams of the second node.

In some implementations of the method and apparatuses described herein, each priority value of the at least one priority value is respectively associated with a transmission power level of a plurality of transmission power levels of the second node.

In some implementations of the method and apparatuses described herein, the first node transmits the at least one priority value to the second node by an Xn interface, an NG interface, or a physical layer connection over the air.

In some implementations of the method and apparatuses described herein, each value of the at least one priority value is a binary value.

In some implementations of the method and apparatuses described herein, each value of the at least one priority value is selected from a predetermined set of at least two values that represent different levels of priority.

In some implementations of the method and apparatuses described herein, the received response includes one or more indication from the second node that indicates whether the second node will adapt its transmission parameters based on the at least one priority value.

In some implementations of the method and apparatuses described herein, the one or more indication is an acknowledgement (ACK) or negative acknowledgement (NACK) for each indicated priority, and

In some implementations of the method and apparatuses described herein, the ACK indicates that the second node will adapt its transmission parameters based on the associated priority value, and the NACK indicates that the second node will not adapt its transmission parameters based on the associated priority value.

In some implementations of the method and apparatuses described herein, the first node only transmits priority values that are above a predetermined threshold that is configured by the core network or the second node.

In some implementations, a user equipment includes a processor and a transceiver coupled to the processor, wherein the processor is configured to select at least one priority value based on at least one criterion, transmit a message including the at least one priority value to a node in the same network as the user equipment, and receive a response to the message from the node, wherein the user equipment receives cross-link interference from the node.

In some implementations, a processor for wireless communication includes at least one memory and a controller coupled with the at least one memory and configured to cause the controller to select at least one priority value based on at least one criterion, transmit a message including the at least one priority value to a node in the same network as the processor, and receive a response to the message from the node, wherein the processor is comprised in user equipment that receives cross-link interference from the node.

In some implementations, a base station includes a processor and a transceiver coupled to the processor, wherein the processor is configured to select at least one priority value based on at least one criterion, transmit a message including the at least one priority value to a node in the same network as the base station, and receive a response to the message from the node, wherein the base station receives cross-link interference from the node.

In some implementations, a method performed by a user equipment includes selecting at least one priority value based on at least one criterion, transmitting a message including the at least one priority value to a node in the same network as the user equipment, and receiving a response to the message from the node, wherein the user equipment receives cross-link interference from the node.

### BRIEF DESCRIPTION OF THE DRAWINGS

FIG. 1 illustrates an example of a wireless communications system that supports prioritization in the presence of crosslink interference in accordance with aspects of the present disclosure.

FIG. 2 illustrates an example of QoS flows in a 5G network.

FIG. 3 illustrates an example of CLI between nodes in a telecommunications network.

FIG. 4 illustrates an example of a block diagram of a device that supports prioritization in the presence of crosslink interference in accordance with aspects of the present disclosure.

FIGS. 5 and 6 illustrate flowcharts of methods that support prioritization in the presence of crosslink interference in accordance with aspects of the present disclosure.

FIG. 7 illustrates an example of a block diagram of a processor that supports prioritization in the presence of crosslink interference in accordance with aspects of the present disclosure.

### DETAILED DESCRIPTION

In dynamic time division duplex (TDD) and sub-band full duplex (SBFD) systems, gNB-gNB and UE-UE crosslink interference (CLI), if not handled appropriately, can limit and degrade system performance compared to static TDD. In practice, every aggressor node typically has multiple victims. Finding an optimal trade-off between maximizing the aggressor's own signal and minimizing the CLI towards the victims becomes harder, if not impossible, in a conventional system. Therefore, prioritizing the victims at the aggressor node so that the aggressor can satisfy its own communication QoS requirement, while limiting the CLI towards, at least, the high priority victims, can substantially improve system performance.

In an embodiment of the present disclosure, a victim node, which could be a UE or gNB that receives interference from an aggressor node (gNB or UE), provides information to the aggressor node so that the aggressor node can adjust parameters in consideration of one or more criteria of QoS requirements of the UEs connected to the aggressor node, QoS requirements of the UEs connected to the victim nodes, the beam-pair (channel/link) quality (e.g., RSRP) of a beam connecting the aggressor and its communicating-end, the beam-pair (channel/link) quality (e.g., RSRP) of the beam connecting victims to their communicating-ends, and the beam-pair coupling (channel/link) between the aggressor node and the victim node.

When a network entity such as a gNB is capable of simultaneous reception and transmission (capable of full duplexing with a certain level of self-interference suppression) within a carrier, the network entity can configure a first sub-band of a carrier as an uplink resource and a second sub-band of the carrier not overlapping with the first sub-band as a downlink resource for sub-band based full duplex operation within the carrier at least for a certain duration. In some examples, the first sub-band and the second sub-band may at least partially overlap.

In an implementation, a UE receives information of a time and frequency resource (e.g. full duplex UL sub-band) for UL transmission on at least some symbols configured as DL or flexible symbols and/or a time and frequency resource (e.g. full duplex DL sub-band) for DL reception on at least some symbols configured as UL or flexible symbols, where the configuration of symbols as DL, UL, or flexible symbols is provided by tdd-UL-DL-ConfigurationCommon and additionally by tdd-UL-DL-ConfigurationDedicated, if configured. The information of a full duplex UL sub-band and/or full duplex DL sub-band may be signaled as part of system information and/or as part of a UE-specific configuration (e.g. bandwidth part configuration).

The node that receives interference on one or more of these sub-bands may determine priority values for each sub-band, transmit those priority values to the node that causes the interference, and receive a response to the transmitted priority values. The response may indicate whether and/or how the interfering node will adapt parameters in consideration of the priority values. In this way, nodes in a CLI environment can selectively and intelligently adapt parameters in an efficient manner that minimizes negative impacts to the network.

Aspects of the present disclosure are described in the context of a wireless communications system. Aspects of the present disclosure are further illustrated and described with reference to device diagrams and flowcharts.

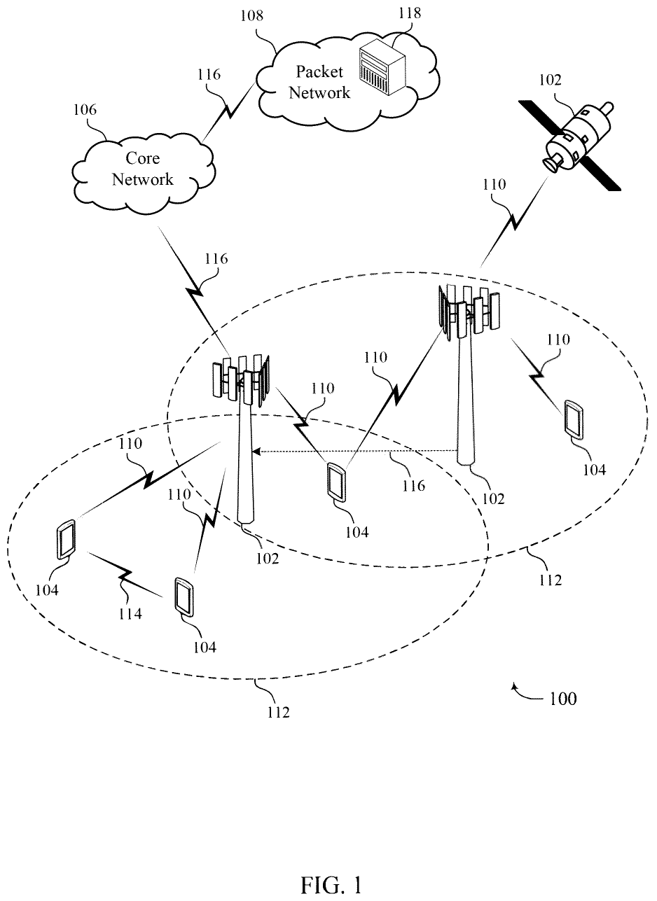

FIG. 1 illustrates an example of a wireless communications system 100 that supports prioritization in the presence of crosslink interference in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHZ), FR3 (7.125 GHZ-24.25 GHz), FR4 (52.6 GHz-114.25 GHz), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The 5G QoS model is based on QoS Flows and supports both QoS Flows that require a guaranteed flow bit rate (GBR QoS Flows) and QoS Flows that do not require a guaranteed flow bit rate (non-GBR QoS Flows). At the NAS level, the QoS flow is thus the finest granularity of QoS differentiation in a PDU session. A QoS flow is identified within a PDU session by a QoS Flow ID (QFI) carried in an encapsulation header over the next generation user plane (NG-U).

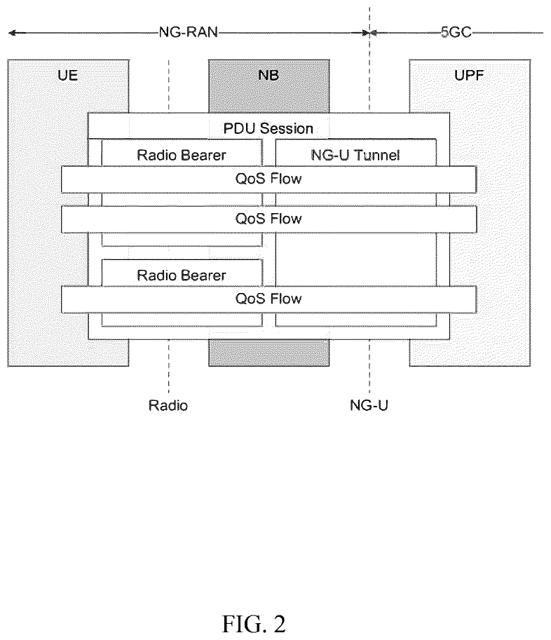

The QoS architecture in an NG-RAN, both for NR connected to a 5GC and for E-UTRA connected to the 5GC, is depicted in FIG. 2. In the QoS architecture, for each UE, the 5GC establishes one or more PDU Sessions. Except for narrowband (NB)-IoT and integrated access and backhaul-mobile termination (IAB-MT) in standalone (SA) mode, for each UE, the NG-RAN establishes at least one Data Radio Bearer (DRB) together with the PDU Session and additional DRB(s) for QoS flow(s) of that PDU session can be subsequently configured (it is up to NG-RAN when to do so). If NB-IoT UE supports NG-U data transfer, the NG-RAN may establish Data Radio Bearers (DRB) together with the PDU Session and one PDU session maps to only one DRB.

The NG-RAN maps packets belonging to different PDU sessions to different DRBs. NAS level packet filters in the UE and in the 5GC associate UL and DL packets with QoS Flows, and AS-level mapping rules in the UE and in the NG-RAN associate UL and DL QoS Flows with DRBs.

NG-RAN and 5GC ensure quality of service (e.g. reliability and target delay) by mapping packets to appropriate QoS Flows and DRBs. Hence there is a 2-step mapping of IP-flows to QoS flows (NAS) and from QoS flows to DRBs (Access Stratum).

At the NAS level, a QoS flow is characterized by a QoS profile provided by the 5GC to the NG-RAN and QoS rule(s) provided by the 5GC to the UE. The QoS profile is used by NG-RAN to determine the treatment on the radio interface while the QoS rules dictate the mapping between uplink User Plane traffic and QoS flows to the UE. A QoS flow may either be GBR or Non-GBR depending on its profile.

The QoS profile of a QoS flow contains QoS parameters. For instance, each QoS flow includes a 5G QoS Identifier (5QI) and an Allocation and Retention Priority (ARP). For GBR QoS flows, the flow includes a Guaranteed Flow Bit Rate (GFBR) for both uplink and downlink, a-Maximum Flow Bit Rate (MFBR) for both uplink and downlink, a-Maximum Packet Loss Rate for both uplink and downlink, a Delay Critical Resource Type and a Notification Control. The Maximum Packet Loss Rate (UL, DL) is generally only provided for a GBR QoS flow belonging to voice media. For non-GBR QoS flows, the flows include a Reflective QoS Attribute (RQA). The RQA, when included, indicates that some (not necessarily all) traffic carried on this QoS flow is subject to reflective quality of service (RQoS) at NAS. Non-GBR flows include additional QoS Flow Information as well.

The QoS parameter Notification Control indicates whether notifications are requested from the RAN when the GFBR can no longer (or again) be fulfilled for a QoS Flow. If, for a given GBR QoS Flow, notification control is enabled and the RAN determines that the GFBR cannot be guaranteed, the RAN sends a notification to a session management function (SMF) and keeps the QoS Flow (while the NG-RAN is not delivering the requested GFBR for this QoS Flow), unless specific conditions at the NG-RAN require the release of the NG-RAN resources for this GBR QoS Flow, e.g. due to Radio link failure or RAN internal congestion. When applicable, the NG-RAN sends a new notification informing the SMF that the GFBR can be guaranteed again.

If Alternative QoS parameters Sets are received with the Notification Control parameter, the NG-RAN may also include in the notification a reference corresponding to the QoS Parameter Set which it can currently fulfil as specified in TS 23.501. The target NG-RAN node may include in the notification control indication the reference to the QoS Parameter Set which it can currently fulfil over an Xn interface to the source NG-RAN node during handover.

In addition, an Aggregate Maximum Bit Rate is associated to each PDU session (Session-AMBR) and to each UE (UE-AMBR). The Session-AMBR limits the aggregate bit rate that can be expected to be provided across all Non-GBR QoS Flows for a specific PDU Session and is ensured by the UPF. The UE-AMBR limits the aggregate bit rate that can be expected to be provided across all Non-GBR QoS Flows of a UE and is ensured by the RAN, as described in clause 10.5.1.

The 5QI is associated to QoS characteristics providing guidelines for setting node specific parameters for each QoS Flow. Standardized or pre-configured 5G QoS characteristics are derived from the 5QI value and are not explicitly signaled. Signaled QoS characteristics are included as part of the QoS profile. The QoS characteristics may include a priority level, a Packet Delay Budget (PDB) which may include a Core Network Packet Delay Budget, a Packet Error Rate (PER), an averaging window, and a Maximum Data Burst Volume (MDBV).

At the Access Stratum level, the data radio bearer (DRB) defines the packet treatment on the radio interface (Uu). A DRB serves packets with the same packet forwarding treatment. The QoS flow to DRB mapping by the NG-RAN is based on QFI and the associated QoS profiles (QoS parameters and QoS characteristics). Separate DRBs may be established for QoS flows requiring different packet forwarding treatment, or several QoS Flows belonging to the same PDU session can be multiplexed in the same DRB.

In uplink, the mapping of QoS Flows to DRBs is controlled by mapping rules which are signaled in two different ways. The first way is reflective mapping, in which for each DRB, the UE monitors the QFI(s) of the downlink packets and applies the same mapping in the uplink; that is, for a DRB, the UE maps the uplink packets belonging to the QoS flows(s) corresponding to the QFI(s) and PDU Session observed in the downlink packets for that DRB. To enable this reflective mapping, the NG-RAN marks downlink packets over Uu with QFI. The second way is an explicit configuration, in which QoS flow to DRB mapping rules can be explicitly signaled by the RRC.

The UE applies the latest update of the mapping rules regardless of whether it is performed via reflecting mapping or explicit configuration. When a QoS flow to DRB mapping rule is updated, the UE sends an end marker on the old bearer.

In downlink, the QFI is signaled by the NG-RAN over Uu for the purpose of RQoS and if neither NG-RAN, nor the NAS (as indicated by the RQA) intend to use reflective mapping for the QoS flow(s) carried in a DRB, no QFI is signaled for that DRB over Uu. In the uplink, NG-RAN can configure the UE to signal QFI over Uu.

For each PDU session, a default DRB may be configured: if an incoming UL packet matches neither an RRC configured nor a reflective mapping rule, the UE then maps that packet to the default DRB of the PDU session. For non-GBR QoS flows, the 5GC may send to the NG-RAN the Additional QoS Flow Information parameter associated with certain QoS flows to indicate that traffic is likely to appear more often on them compared to other non-GBR QoS flows established on the same PDU session.

Within each PDU session, the NG-RAN determines how to map multiple QoS flows to a DRB. The NG-RAN may map a GBR flow and a non-GBR flow, or more than one GBR flow to the same DRB, but mechanisms to optimize these cases are not within the current scope of standardization.

Various embodiments of the present disclosure make reference to aggressor and victim entities. It should be appreciated that these terms may not refer to a characteristic of the entity itself, but instead refer to an effect of the entity's communication of signals. In particular, when a receiver receives an intended signal from an intended transmitter, it may also receive unintended signals from an unintended transmitter operating on the same frequency at the same time. In this situation, the unintended signal is an interference, the unintended transmitter may be referred to as an aggressor entity, and the receiver may be referred to as a victim entity of the interference. Therefore, in this general sense, the notions of aggressor entity and victim entity may be specific to each communication, potentially independent of the type of the entities (e.g., gNB versus UE), their class or power level (e.g., macro gNB versus small-cell gNB), etc.

It should be noted that the terms aggressor and victim may or may not directly appear in the standard specification. The use of these terms in the present disclosure is for ease of reference, and should not be interpreted as limiting any entity to a particular class or type.

Various embodiments of the present disclosure make reference to beamforming-related terms such as beam, antenna, and so on. Despite reference to such plain terms in the present disclosure, the terminology adopted in the 3GPP specification makes use of a range of other terms. Some of these terms are described below.

The terms beam and beamforming may refer to applying a spatial filter, in analog or digital domains, when transmitting or receiving a signal by one or multiple antennas, antenna panels, antenna elements, or the like. Therefore, the term beam may refer to a signal processed by a spatial filter in the analog domain on a transmitting antenna or a receiving antenna, a spatial filter in the digital domain, a reference signal transmitted while applying a spatial filter, a resource associated with the reference signal, or the like. Similarly, a beam index may refer to an index or ID associated with a spatial filter, a reference signal, or a reference signal resource.

In the present disclosure, the terms antenna, panel, and antenna panel may be used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or multiple spatial directions.

In some embodiments, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices such as a centralized unit (CU), it can be used for signaling or local decision making.

In some embodiments, an antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on implementation, a “panel” can have at least one of the following functionalities as an operational role of Unit of antenna group to control its Tx beam independently, Unit of antenna group to control its transmission power independently, Unit of antenna group to control its transmission timing independently. The “panel” may be transparent to another node (e.g., next hop neighbor node). For certain conditions, another node or network entity can assume the mapping between a device's physical antennas to the logical entity “panel” may not be changed. For example, the condition may include until the next update or report from device or comprise a duration of time over which the network entity assumes there will be no change to the mapping. A device may report its capability with respect to the “panel” to the network entity. The device capability may include at least the number of “panels”. In one implementation, the device may support transmission from one beam within a panel; with multiple panels, more than one beam (one beam per panel) may be used for transmission. In another implementation, more than one beam per panel may be supported/used for transmission.

In some of the embodiments described herein, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, QCL-Type may take one of the following values. Other QCL-Types may be defined based on combination of one or large-scale properties:

‘QCL-TypeA’: {Doppler shift, Doppler spread, average delay, delay
spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where the device may not be able to perform omni-directional transmission, so that the device would need to form beams for directional transmission. For a QCL-TypeD between two reference signals A and B, the reference signal A is considered to be spatially co-located with reference signal B and the device may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some embodiments, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between a serving gNB and a smart repeater). In some embodiments, a TCI state comprises at least one source RS to provide a reference (device assumption) for determining QCL and/or spatial filter.

In some embodiments, a UL TCI state is provided if a device is configured with separate DL/UL TCI by RRC signaling. The UL TCI state may comprise a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some embodiments, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with QCL-Type set to ‘typeD’ in the joint TCI state.

In some embodiments, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some embodiments, a UL TCI state is provided if a device is configured with separate DL/UL TCI by RRC signaling. The UL TCI state may comprise a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some embodiments, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

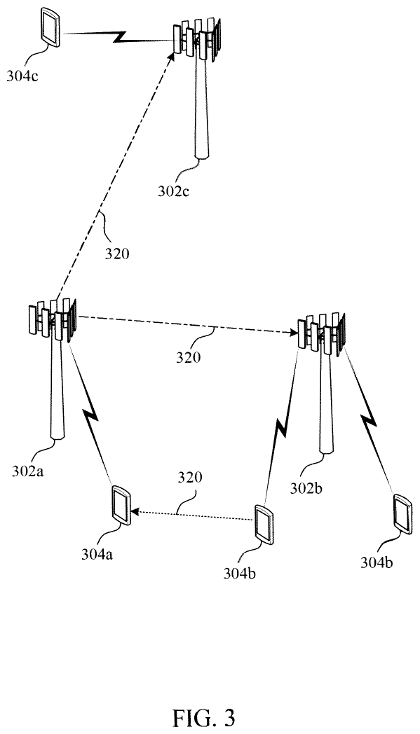

FIG. 3 illustrates an example of network communications in the presence of CLI between various network nodes. In the scenario illustrated in FIG. 3, a system includes three gNBs, each serving one or more UEs. For the communication example in FIG. 3, a first gNB 302a is communicating in downlink, while a second gNB 302b and a third gNB 302c are communicating in uplink using the same frequencies as the first gNB 302a. Accordingly, transmissions from the first gNB 302a cause CLI 320 to the second and third gNBs 302b and 302c. Here, the first gNB 302a acts as an aggressor node while the second and third gNBs 302b and 302c are victim nodes.

In practice, UE traffic (UL or DL) may be characterized by one or multiple QoS requirements, such as a maximum delay/latency requirement and/or a minimum transmission rate requirement, while a communication link (UL or DL) may be characterized by a link quality, e.g., in terms of RSRP.

In the situation illustrated in FIG. 3, it is preferable for the first gNB 302a to adapt its transmission parameters to reduce or eliminate CLI to the second and third gNBs 302b and 302c while meeting its own QoS requirements. However, due to the limited resources available to the first gNB 302a (e.g., beam, power, bandwidth) and the practical realities of asynchronous TDD using the same frequencies, it may not be possible for the gNB to reduce or eliminate CLI 320 to the neighboring gNBs 302b and 302c while meeting the QoS requirements for communication with UEs 304a that are receiving downlink communications from the first gNB 302a. For example, the aggressor gNB 302a may be able to adapt its parameters so that one of the victim gNBs can satisfy its QoS requirements but the other cannot.

In an embodiment, the victim gNBs 304b and 304c send priority information to the aggressor gNB 302a so that the aggressor gNB can adapt parameters to meet the QoS requirements of both victim nodes. For example, gNB 302a may select a Tx DL beam to serve UE 304a that meets the QoS requirements for that transmission while causing low CLI to the second gNB 302b, even though the selected beam may increase the CLI to the third gNB 302c. This beam selection may be made based on the second gNB 302b having a higher priority than third gNB 302c at the time.

In another example, the first gNB 302a may select another Tx DL beam to serve UE 304a, regardless of the effects of CLI on victim nodes 302b and 302c. This beam selection may be made when UE 304a has a QoS requirement that is stricter than UEs 304b and 304c that are being served by the victim nodes 302b and 302c. In another embodiment, this beam selection may be made in consideration of a high level of link quality between UEs 304b and 304c and their serving gNBs, so that those links can handle the observed gNB-gNB CLI.

A UE can cause or experience CLI as well as a base station. For example, FIG. 3 shows UE 304a experiencing CLI 320 from UE 304b when UE 304b transmits on frequencies and times at which UE 304a is receiving. Accordingly, in general, the victim and aggressor nodes described by the following description could be UEs as well as base stations.

Although embodiments are described with respect to dynamic TDD systems, the same principles can be applied to SBFD-based systems as well, or any system that experiences CLI between nodes.

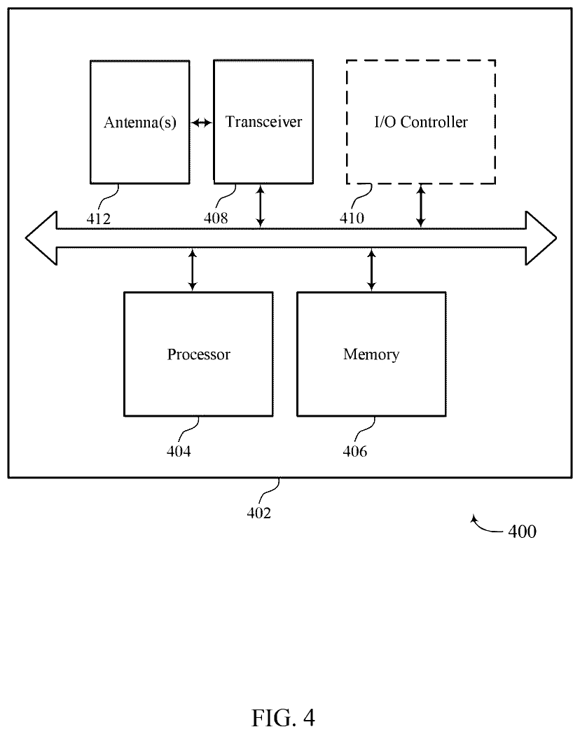

FIG. 4 illustrates an example of a block diagram 400 of a device or node 402 that supports prioritization in the presence of crosslink interference in accordance with aspects of the present disclosure. The device 402 may be an example of a network entity 102 or a UE 104 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. Processor 404 may be configured as or otherwise support a means for selecting at least one priority value based on at least one criterion, transmitting a message including the at least one priority value to a node in the network, and receiving a response to the message from the node.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor 404. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

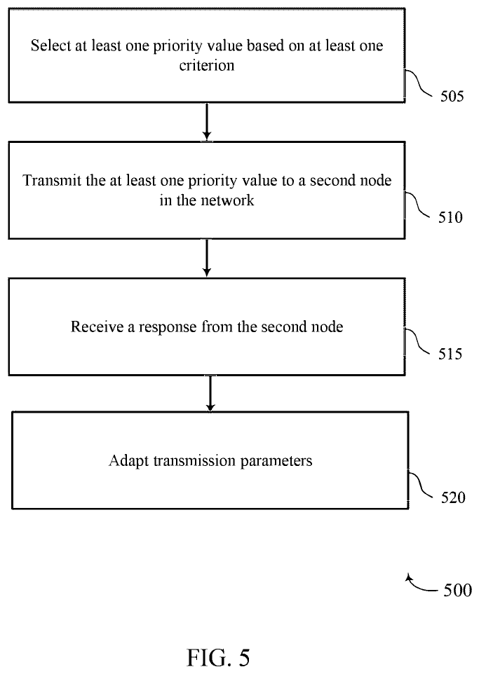

FIG. 5 illustrates a flowchart of a method 500 that supports prioritization in the presence of crosslink interference in accordance with aspects of the present disclosure. The operations of the method 500 may be implemented by a device or its components as described herein. For example, the operations of method 500 may be performed by a node such as a network entity or base station 102/302 or a UE 104/304 as described with reference to FIGS. 1, 3 and 4. In some implementations, the device may execute a set of instructions to control the function elements of the device to perform the described functions. Additionally, or alternatively, the device may perform aspects of the described functions using special-purpose hardware.

At 505, the method may include selecting at least one priority value based on at least one criterion. The operations of 505 may be performed in accordance with examples as described herein. In some implementations, aspects of the operations of 505 may be performed by a device as described with reference to FIG. 1.

The entity that performs 505 and other elements of process 500 may be a network node such as a gNB or UE that receives CLI from another node in the network. In the following examples, as explained above, the node that receives the interference may be referred to as a victim node. The priority value may be selected, for example, from a pair of binary values, a set of integer values, or calculated or determined as described in the following embodiments. Accordingly, selecting a priority value may include calculating or otherwise determining a priority value.

In an embodiment, the victim node selects at least one priority value based on a criterion that is one or more QoS requirement of the traffic at that node, and in particular, traffic that is affected or anticipated to be affected by CLI from the aggressor node. Examples of the QoS requirements include maximum delay, minimum data rate, and minimum reliability level.

The priority level may scale according to the QoS requirements, such that higher priority levels are associated with higher QoS requirements, and lower priority levels are assigned for lower QoS requirements. For example, a victim node may associate a high priority level with delay critical traffic, and a low priority value for traffic that is less affected by delay.

In an embodiment, the victim node selects at least one priority value based on a criterion that is associated with the beam-pair (link, channel) quality connecting the victim node to its communication-end. The beam-pair quality can be, for example, a measure of one or more of a received signal strength indicator (RSSI), reference signal received power (RSRP) and reference signal received quality (RSRQ) between different beam pairs.

The priority value may vary inversely with the quality of the channel. For example, the victim node may select or assign a lower priority value for higher channel quality, and assign a higher priority value for lower channel quality. Accordingly, the priority value in this case represents the sensitivity of the channel to interference, so that interference reduction measures enacted by an aggressor node can be made to preserve or improve weaker or more vulnerable channels of victim nodes.

In an embodiment, the victim node selects at least one priority value based on a criterion that is the beam-pair coupling between the victim node and an aggressor node. The beam-pair coupling may be determined by direct measurements of the interference from the aggressor node, or measurements of other signals of the aggressor node by the victim node. In various embodiments, the beam-pair coupling may be one or more of an RSSI, RSRP and RSRQ value measured by the victim node.

The priority level may scale according to the beam-pair coupling, such that higher priority levels are associated with higher beam-pair coupling levels, and lower priority levels are assigned for lower beam-pair coupling levels. For example, a victim node associates a low priority level if the coupling is weak, which suggests that the victim node may be less affected by parameter changes by the aggressor node. In an embodiment, the priority level is based on both the beam-pair quality connecting the victim node to its communication-end and the beam-pair coupling between the victim node and an aggressor node.

At 510, the method may include transmitting the at least one priority value to a second node in the network. The operations of 510 may be performed in accordance with examples as described herein. In some implementations, aspects of the operations of 510 may be performed by a device as described with reference to FIG. 1. Here, the second node is an aggressor node that is causing CLI to the first node.

In an embodiment, the victim node only transmits the priority value if the value is above a certain threshold. The threshold can be a preconfigured value retained by the first node, or a value that is received prior from, for example, the core-network or the aggressor node. The victim node may transmit the priority value to the aggressor node over an Xn or NG interface, or by a physical layer over the air (OTA) connection.

In various embodiments, the priority value, denoted here by β, can be a plurality of values, or a value within an interval of values indicated by a minimum value and a maximum value such as β∈[βₘᵢₙ, βₘₐₓ]. In one embodiment, the priority value is a binary value representing a high or low priority:

| | |
|---|---|
| Low, or 0 | If β ≤ β_{threshold} |
| High, or 1 | If β > β_{threshold} |

In another embodiment, the priority value is selected from a predetermined set of values each representing a different priority level. For example, the priority value may be selected from a set of five different values that respectively represent the following five priority levels:

| | |
|---|---|
| Very Low | e.g., if β ≤ 0.1 |
| Low | e.g., if 0.1 < β ≤ 0.4 |
| Medium | e.g., if 0.4 < β ≤ 0.6 |
| High | e.g., if 0.6 < β ≤ 0.8 |
| Very High | e.g., if 0.8 < β ≤ 1 |

At 515, the method may include receiving a response to the message from the second node. The operations of 515 may be performed in accordance with examples as described herein. In some implementations, aspects of the operations of 515 may be performed by a device as described with reference to FIG. 1.

The victim node may be indicated by an acknowledgment (a positive or a negative acknowledgment ACK or NACK) from the aggressor node at 515 indicating whether or not the aggressor node will adapt its transmission parameters based on the received priority value. In an embodiment, the ACK/NACK is explicitly sent to the victim in a response message. In another implementation, when no response message is received from the aggressor node in response to the priority value transmitted at 510, the victim node assumes that the aggressor node will not adapt its transmission parameters based on the priority value. In other words, a NACK may be implicitly indicated by not transmitting a response message. The victim node may determine an implicit NACK if no response is received from the aggressor within a predetermined time.

At 520, the method may include adapting transmission parameters based on the at least one priority value. The operations of 520 may be performed in accordance with examples as described herein. In some implementations, aspects of the operations of 520 may be performed by a device as described with reference to FIG. 1.

If a NACK is indicated by an aggressor at 515, explicitly or implicitly, the victim node may change its transmission strategy at 520. For example, the victim node may change its communication beam, decrease or increase its transmission power, and/or cancel one or more data transmission.

In another embodiment, a victim node transmits multiple priority values/levels for multiple sub-bands at 505 which are selected based on a predefined criterion, to one or more of the aggressor nodes. In some implementations, the victim node only transmits the priority levels if they are above a certain threshold, wherein the priority threshold can be a preconfigured value or received from the core-network entity or an aggressor node. In such an embodiment, the victim node may select its priority values for multiple sub-bands, where each sub-band is characterized by a number of time-frequency resources, e.g. a number of resource blocks (RBs).

For example, when the victim node and the aggressor node are sharing B sub-bands, the victim node may calculate B priority values, one for every sub-band, while considering the QoSs of traffic. When the victim node is a gNB node serving K QoS flows per sub-band, the victim node may calculate B·K priority levels, one for every sub-band and QoS flow. A QoS flow may be associated with a QoS flow identifier (QFI). Data traffic associated with a UE may be divided to one or multiple QoS flows. In an embodiment in which each UE is assigned to one QoS flow, K may indicate the number of UEs.

In one implementation, the victim node transmits a single priority level to the aggressor node, e.g., as the one corresponding to the highest priority QoS flow or UE or as an average of the B·K priority levels. In embodiment, the victim node transmits multiple priority levels, each priority level being associated with a respective sub-band.

In another embodiment, a victim node transmits multiple priority values for multiple beams, which are selected based on a predefined criterion, to one or more aggressor node at 510. In such an embodiment, the victim node selects a priority value at 505 for each beam that causes CLI from an aggressor node.

Each beam may be characterized by a beam index, such as a reference signal index, or a TCI state. For example, if the victim node has Ny beams and the aggressor node has Na beams, the node may calculate N=Nₐ·Nᵥ priority values, one for every beam-pair, while considering the QoSs of a UE's traffic. In an embodiment in which both the victim node and the aggressor nodes are gNBs and the victim node is serving K QoS flows, the victim node in this case may calculate N·K priority levels, one for every beam pair and QoS flow.

In an embodiment, the victim node transmits a single priority value to the aggressor node. The single priority value may be, for example, the highest priority value for affected QoS flows, or an average of the N·K priority levels. In another embodiment, the victim node transmits multiple priority levels each corresponding to a respective beam at 510.

According to another embodiment, a victim node transmits multiple priority values for multiple transmit-power levels per beam to one or more aggressor node at 510. The priority values in this embodiment may be selected at 505 based on a predefined criterion such as a QoS level associated with the beam.

For example, in the case that the aggressor node has P transmit-power levels per beam, the victim node may calculate P priority values, one for every transmit-power level, in which the criteria are QoS requirements of the associated UE's traffic. In an embodiment in which the victim node and the aggressor node are gNBs, where the victim node is serving K QoS flows, the victim node may calculate P·K priority values, one for every transmit-power level and QoS flow.

In one embodiment, the victim node transmits a single priority value to the aggressor node at 510, and the single priority value may be the priority value corresponding to the highest priority QoS flow or as an average of the P·K priority levels. In another embodiment, the victim node transmits multiple priority values, one per transmit-power-level.

In some of the embodiments described above a victim node transmits multiple priority levels, one for every sub-band, beam-pair, and transmit-power level. In an embodiment in which the victim node is a gNB node serving K QoS flows per sub-band, the node may calculate B·N·P·K priority values. In other embodiments, the victim node transmits a single priority level corresponding to the highest priority QoS flow or an average of the B·N·P·K priority levels to the aggressor node. In another embodiment, the victim node transmits multiple priority levels: one per-sub-band, beam, and/or transmit-power level.

In some embodiments, the victim node receives CLI from multiple aggressor nodes. In such a case, the victim node may transmit priority values to all transmitters from which it receives CLI at 510. The victim node may only transmit priority values to nodes that create CLI above a threshold value.

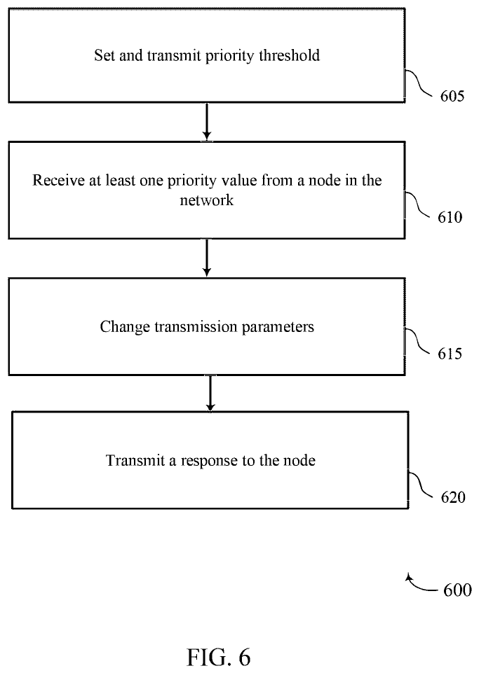

FIG. 6 illustrates a flowchart of a method 600 that supports prioritization in the presence of crosslink interference in accordance with aspects of the present disclosure. The operations of the method 600 may be implemented by a device or its components as described herein. For example, the operations of method 600 may be performed by a node such as a network entity or base station 102/302 or a UE 104/304 as described with reference to FIGS. 1, 3 and 4. In some implementations, the device may execute a set of instructions to control the function elements of the device to perform the described functions. Additionally, or alternatively, the device may perform aspects of the described functions using special-purpose hardware. The entity that performs process 600 may be a network node such as a gNB or UE that causes CLI to another node in the network.

At 605, the method may include setting and transmitting a priority threshold. The operations of 605 may be performed in accordance with examples as described herein. In some implementations, aspects of the operations of 605 may be performed by a device as described with reference to FIG. 1.

The node may set a priority threshold based on local information, including one or more QoS requirement for its own transmissions, the existing radio environment, hardware constraints, etc. The node may then transmit the priority value to neighboring nodes through a wire or radio link. In an embodiment, the priority threshold is transmitted in the response to a victim node message at 620.

At 610, the method may include receiving at least one priority value from a node in the network. The operations of 610 may be performed in accordance with examples as described herein. In some implementations, aspects of the operations of 610 may be performed by a device as described with reference to FIG. 1.

The at least one priority value at 610 may be received from the node that is a victim of CLI from the receiving node. When the receiving node causes CLI to multiple nodes, priority values may be received from any or all of the victim nodes at 610. The priority value received at 610 may be the priority value that is transmitted at 510 as described above.

In an embodiment, victim nodes only transmit priority values at 510 when they exceed the threshold value from 605. In this case, only priority values that exceed the threshold value are received at 610.

At 615, the method may include changing one or more transmission parameter based on the priority values received at 610. The operations of 615 may be performed in accordance with examples as described herein. In some implementations, aspects of the operations of 615 may be performed by a device as described with reference to FIG. 1.

In an embodiment, the aggressor node calculates priority values for its own transmission links at 505. This calculation may be performed since each victim node in a dynamic TDD system may also be an aggressor node to neighboring nodes using the same frequencies. However, even an aggressor node is not a victim node, the aggressor node may still determine priority values for its transmission links.

Next, the node may arrange the local priority values and priority values received at 610 in order, and select transmission parameters that satisfy the highest ranked priority values first, and lower ranked priority values if possible. In an embodiment, the node may use the local and the received priority values at 615 to calculate or select transmission resources, e.g. beam, sub-band, and transmit-power level, that satisfy its QoS requirements while improving or satisfying QoS requirements for one or more victim node.

For example, the node may use transmission parameters that satisfy QoS requirements for its own communication links first, or parameters that satisfy the highest rank transmission parameters first. In an embodiment in which the highest priority value of all nodes is used, the locally determined priority value may be used as the basis for changing transmission parameters at 615 when the aggressor node has a higher QoS requirement, the coupling between aggressor and victim is weak, and/or the beam pairs connecting the victim base station and UEs are stronger than the beam-pair connecting the aggressor node and its communication end.

In an embodiment, the aggressor can use the received priority values to determine CLI thresholds of the constraints forming its design problem. An aggressor base station node can select a transmit beam to communicate with a UE as a solution to maximize the signal to noise ratio (SNR) for the UE subject to CLI observed by other nodes being above one or more threshold value. For example, the node may select transmission parameters that maximize the quality of its own communications while satisfying a minimum or CLI threshold condition for communications of neighbors experiencing CLI.

Depending on the received priority values from the victims, the aggressor node can use the victims' priority values to decide on appropriate CLI thresholds at 605. Setting a high CLI threshold could cause a corresponding constraint function to not be considered when selecting the beam. On the other hand, setting a low CLI threshold could result in minimal benefits to the victim node.

In some embodiments, the nodes may test the effects of changing transmission parameters at 615. For example, an aggressor node may adapt a beam and receive feedback from one or more victim node regarding the effects of the adapted beam. Therefore, aspects of methods 500 and 600 could be performed as an iterative process in which aggressor and/or victim nodes adjust parameters and the network tests the effects of the adjustments to improve communications. For example, the nodes could iterate adjustment and feedback until as many QoS requirements are met as possible, until the aggressor QoS requirements are met and as many victim QoS requirements are met as possible, until the average QoS requirement is as high as possible, until as many QoS requirements are met for all communications including the aggressor and victim nodes, etc.

At 620, the method may include transmitting a response to the node. The operations of 620 may be performed in accordance with examples as described herein. In some implementations, aspects of the operations of 620 may be performed by a device as described with reference to FIG. 1.

The aggressor node may indicate an acknowledgment to the to every victim node indicating whether it will use its priorities or not. The acknowledgment may be a positive or a negative acknowledgment (ACK or NACK). The acknowledgment may contain multiple ACK/NACK values each associated with a certain indicated priority. In one implementation, the ACKs/NACKs are explicitly sent to the victim in a response message. In another implementation, a NACK is implicitly indicated by not responding to the corresponding priority value/level.

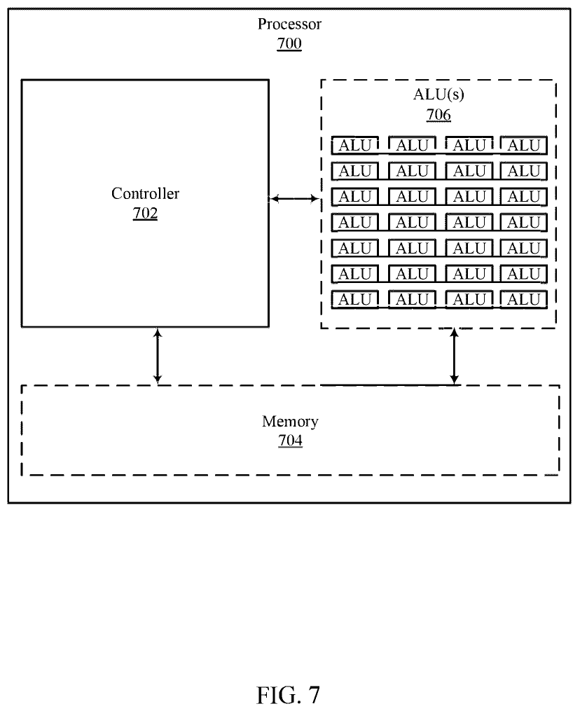

FIG. 7 illustrates an example of a processor 700 that supports prioritization in the presence of crosslink interference in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, such as L1/L2/L3 cache. Additionally, or alternatively, the processor 700 may optionally include one or more arithmetic-logic units (ALUs) 700. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementation, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, and the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 700 may be configured to support various operations in accordance with examples as described herein. In some implementation, the one or more ALUs 700 may reside within or on a processor chipset (e.g., the processor 700). In some other implementations, the one or more ALUs 700 may reside external to the processor chipset (e.g., the processor 700). One or more ALUs 700 may perform one or more computations such as addition, subtraction, multiplication, and division on data. For example, one or more ALUs 700 may receive input operands and an operation code, which determines an operation to be executed. One or more ALUs 700 be configured with a variety of logical and arithmetic circuits, including adders, subtractors, shifters, and logic gates, to process and manipulate the data according to the operation. Additionally, or alternatively, the one or more ALUs 700 may support logical operations such as AND, OR, exclusive-OR (XOR), not-OR (NOR), and not-AND (NAND), enabling the one or more ALUs 700 to handle conditional operations, comparisons, and bitwise operations.

The processor 700 may support wireless communication in accordance with examples as disclosed herein. The processor 700 may be configured to or operable to support a means for prioritization in the presence of crosslink interference.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
select at least one priority value based on at least one criterion;
transmit a message including the at least one priority value to a node in the same network as the user equipment; and
receive a response to the message from the node,
wherein the UE receives cross-link interference from the node.

2. The UE of claim 1, wherein the at least one criterion includes one or more of:
a QoS requirement for a network entity coupled to the UE;
channel quality of a channel that is affected by cross-link interference from the node; and
a power level of the crosslink interference between the UE and the node.

3. The UE of claim 1, wherein each priority value of the at least one priority value is respectively associated with a sub-band of a plurality of sub-bands shared between the UE and the node.

4. The UE of claim 1, wherein each priority value of the at least one priority value is respectively associated with a beam of a plurality of beams of the node.

5. The UE of claim 1, wherein each priority value of the at least one priority value is respectively associated with a transmission power level of a plurality of transmission power levels of the node.

6. The UE of claim 1, wherein each priority value of the at least one priority value is a binary value.

7. The UE of claim 1, wherein each priority value of the at least one priority value is selected from a predetermined set of at least two values that respectively represent different levels of priority.

8. The UE of claim 1, wherein the received response includes one or more indication from the node that indicates whether the node will adapt its transmission parameters based on the at least one priority value.

9. The UE of claim 8, wherein the one or more indication is an acknowledgement (ACK) or negative acknowledgement (NACK) for each indicated priority, and
wherein the ACK indicates that the node will adapt its transmission parameters based on the associated priority value, and the NACK indicates that the node will not adapt its transmission parameters based on the associated priority value.

10. The UE of claim 1, wherein the UE only transmits priority values that are above a predetermined threshold that is configured by the core network or the node.

11. A processor for wireless communication, comprising:
at least one memory; and
at least one controller coupled with the at least one memory and configured to cause the controller to:
select at least one priority value based on at least one criterion;
transmit a message including the at least one priority value to a node in the same network as the processor; and
receive a response to the message from the node,
wherein the processor is comprised in user equipment (UE) that receives cross-link interference from the node.

12.-14. (canceled)

15. A base station for wireless communication, comprising:
at least one memory; and
at least one processor coupled with the at least one memory and configured to cause the base station to:
select at least one priority value based on at least one criterion;
transmit a message including the at least one priority value to a node in the same network as the base station; and
receive a response to the message from the node,
wherein the base station receives cross-link interference from the node.

16. The base station of claim 15, wherein the at least one criterion includes one or more of:
a QoS requirement for user equipment (UE) coupled to the base station;
channel quality of a channel that is affected by cross-link interference from the node; and
a power level of the crosslink interference between the base station and the node.

17. The base station of claim 15, wherein each priority value of the at least one priority value is respectively associated with a sub-band of a plurality of sub-bands shared between the base station and the node.

18. The base station of claim 15, wherein each priority value of the at least one priority value is respectively associated with a beam of a plurality of beams of the node.

19. The base station of claim 15, wherein the processor is further configured to transmit the at least one priority value to the node by an Xn interface, an NG interface, or a physical layer connection over the air.

20. A method performed by a user equipment (UE), the method comprising:
selecting at least one priority value based on at least one criterion;
transmitting a message including the at least one priority value to a node in the same network as the UE; and
receiving a response to the message from the node,
wherein the UE receives cross-link interference from the node.

21. The method of claim 20, wherein the at least one criterion includes one or more of:
a QoS requirement for a network entity coupled to the UE;
channel quality of a channel that is affected by cross-link interference from the node; and
a power level of the crosslink interference between the UE and the node.

22. The method of claim 20, wherein each priority value of the at least one priority value is respectively associated with a sub-band of a plurality of sub-bands shared between the UE and the node.

23. The method of claim 20, wherein each priority value of the at least one priority value is respectively associated with a beam of a plurality of beams of the node.
